(19) United States
(12) Patent Application Publication
(10) Pub. No.: US 2012/0311826 A1
(43) Pub. Date: Dec. 13, 2012

(54) Hold open stabilizer

(76) Inventor: Gerald Paul SanFilippo, Elmhurst, IL (US)

(21) Appl. No.: 13/134,422

(22) Filed: Jun. 8, 2011

(51) Int. Cl. F16B 2/20; F16B 47/00

(52) U.S. Cl. 24/304; 24/570; 24/457

(57) ABSTRACT

A simple apparatus to be affixed to a traditional expandable file jacket which when properly so affixed holds open said jacket so as to allow easy one hand insertion and removal of documents and other materials into and out of said jacket. Also, the said apparatus so affixed to a plurality of said jackets arranged so as to form a system of said easy to use said jackets.

### FIELD OF THE INVENTION

The present invention relates to a filing system utilizing traditional paper folders known as file jackets; in which papers such as documents are stored in an organized manner. The Hold Open Stabilizer, which is the invention, fits onto a said file jacket allowing the said jacket to be held in a “wide-open” position thus allowing said papers or documents to be easily placed into or taken out of the held-open said file jacket using only one hand.

### BACKGROUND OF THE INVENTION

A common practice of organizing paper documents includes placing traditional paper file jackets of the same size one in front of the other as these file jackets are contained in box or in a purpose built and sized drawer. Into said file jackets are placed documents or similar items for the purpose of storing said items where a label or other indication can be affixed to indicate what has been placed into said jacket so said items can be readily retrieved as necessary.

Further, the said box or drawer can be further labeled or identified so future searches to retrieve said stored documents can be achieved with organizational certainty.

Such organizational systems can include, perhaps, as few as six said file jackets on upwards to a system of hundreds or thousands of said file jackets. Often the said jackets are packed tightly one in front of the other inside containing boxes or inside purpose built drawers. The task of locating a certain unique file jacket in a said multi file jacket system and then placing an additions document into said unique jacket usually requires the use of both hands of the person performing the said task; one hand to place said item into the jacket and one hand to hold open the jacket in order to allow the document to enter the jacket. The present invention, when installed onto a traditional file jacket, continually holds open said jacket to the maximum; then the task of placing a document into or removing a document from said file jacket is achieved using only one hand.

### BRIEF SUMMERY OF THE INVENTION

The present invention, The Hold Open Stabilizer, is set forth in this patent application in unique embodiments.

The features of the invention are best understood by examining the six pages of drawings included in this application.

The invention is a rigid device which is attached to the sides of the opening of a file jacket for the purpose of holding open to the maximum the said opening of said jacket through which documents or other items are placed to be contained in said file jacket.

Of the two embodiments of the present invention set forth in this application, one embodiment “clips” onto the said jacket and remains in place on said jacket by the friction between said clip-on and the paper material of which the said jacket is made. The second embodiment is attached to said jacket by means of a pressure-sensitive adhesive. The function and effect of either embodiment presented herein is similar. The clip-on would be the preferred embodiment.

### BRIEF DESCRIPTION OF THE DRAWINGS

The features of the invention will become more apparent and the present invention will be better understood upon consideration of the following drawings wherein:

FIG. 1. Depicts the embodiment of the invention which attaches to a file jacket by sliding over or “clipping” to the top edge of a side of the opening of said jacket; one on each side.

FIG. 2. Depicts the embodiment of the present invention which attaches to a file jacket by means of a pressure-sensitive adhesive; one each on either side; inside or outside surface.

FIG. 3. Is a perspective view of a traditional file jacket with the adhesive-attaching embodiment attached to the inside surface near the top of both sides of said file jacket; thus holding open to the maximum the opening to the inside of said file jacket.

FIG. 4. A perspective view of a traditional file jacket with the clip-on attaching embodiment of the present invention attached to the top edge of both sides of said jacket; thus holding open to the maximum the opening to the inside of said jacket.

FIG. 5. Depicts a file system made possible by the present invention, The Hold Open Stabilizer, illustrated affixed to the traditional file jackets which are further contained in a purpose sized box. The said jackets are held open the maximum allowing easy one hand placement or removal of documents into or out of said folders.

FIG. 6. Depicts a label which might be affixed to a complete file system kit as might be packaged to be sold in a retail store. The label describes and identifies and thus further makes more apparent, and helps to better understand, the present invention.

### DETAILED DESCRIPTIONS OF TWO EMBODIMENTS OF THE INVENTION

The embodiments of the invention described herein are not intended to be exhaustive nor limit the invention to the precise forms disclosed. The embodiments shown and herein described enable one skilled in the art to practice the invention.

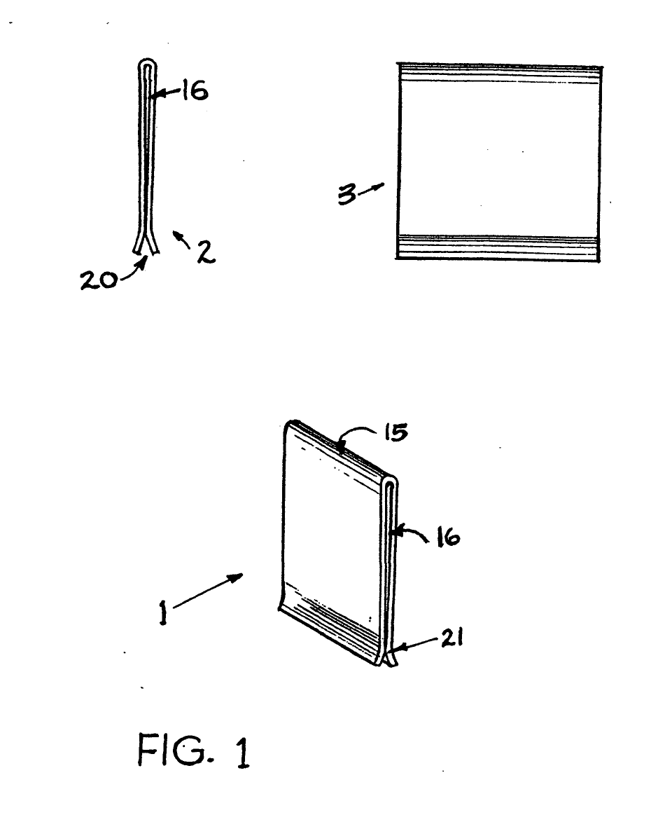

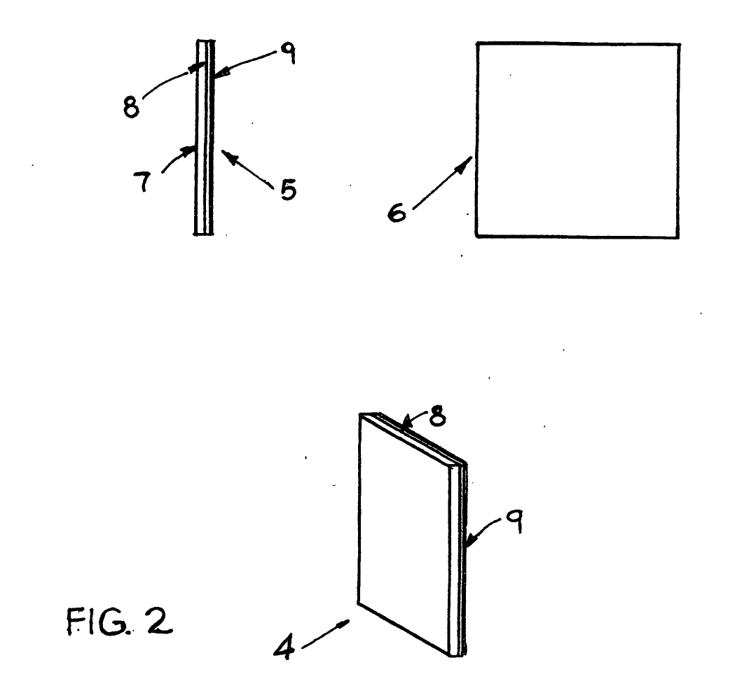

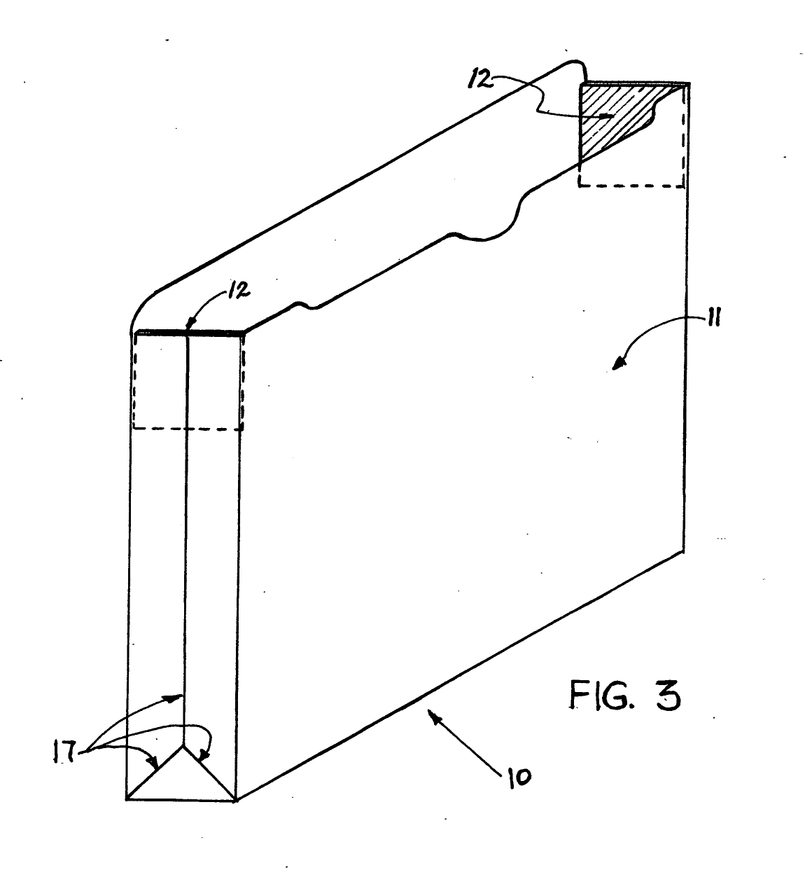

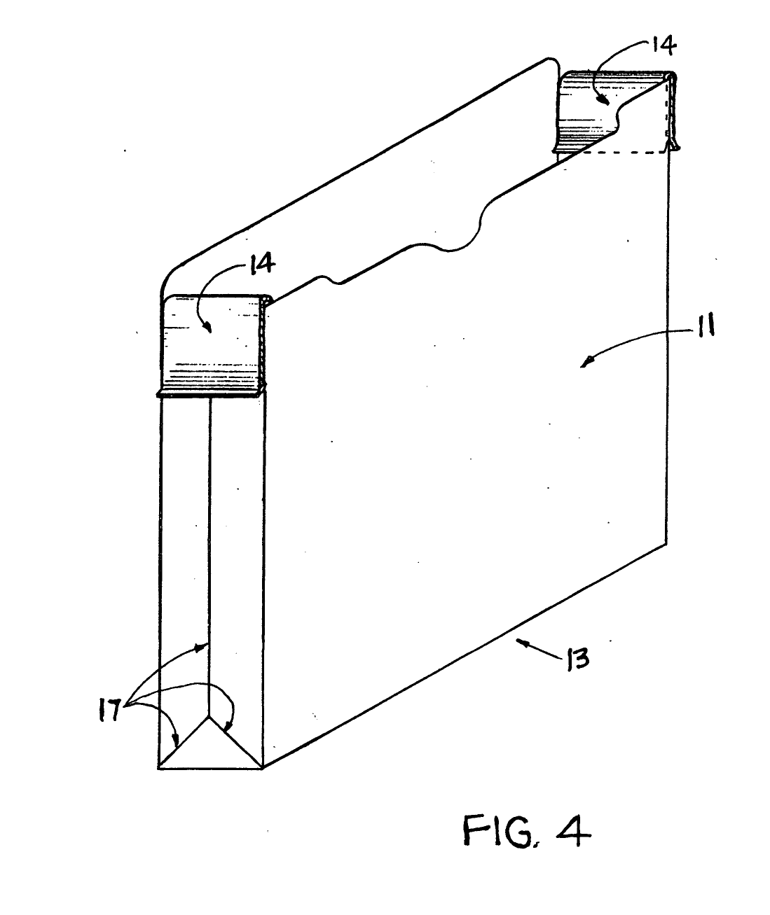

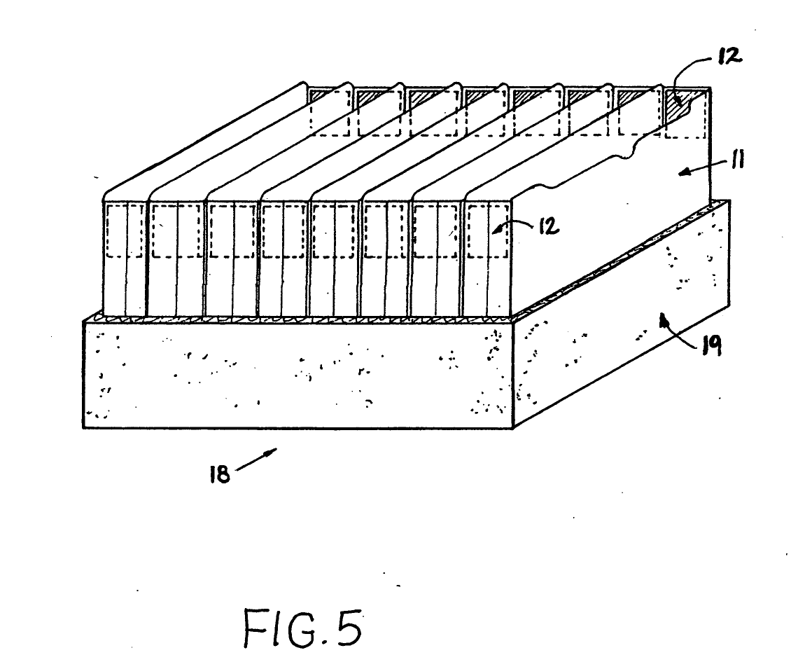

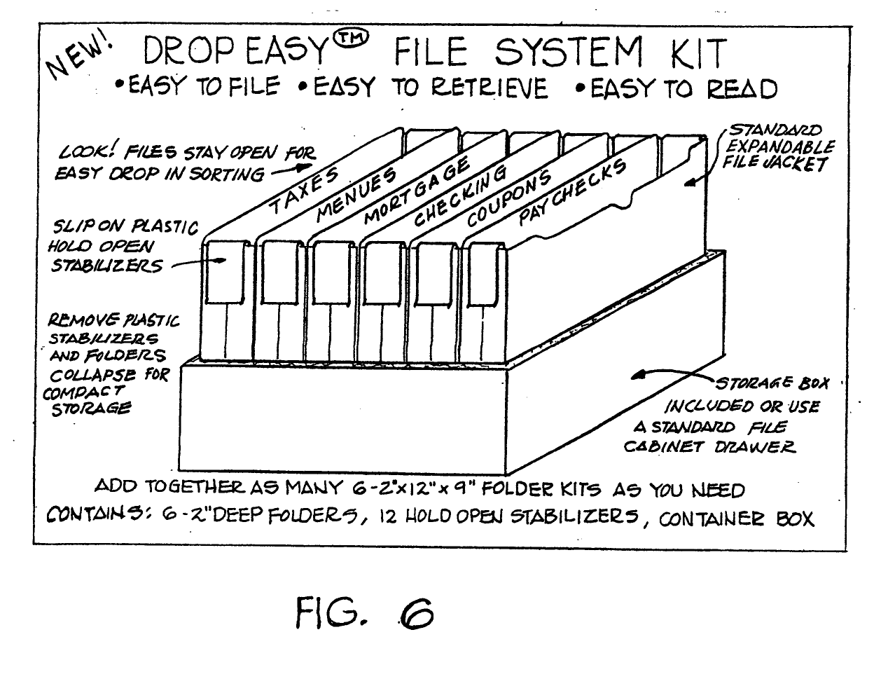

Referring now to the detailed drawings of embodiments of the present invention. The drawings are marked as FIG. 1., FIG. 2., FIG. 3., FIG. 4., FIG. 5. and FIG. 6.

The features of the invention will become more apparent, and the present invention will be better understood upon consideration of the following description and the accompanying drawings wherein:

The accompanying drawings illustrate the present invention. In such drawings, FIG. 1. depicts the preferred embodiment of the invention. A perspective view is numbered 1. An end view of the invention is numbered 2. (The opposite end view of the invention is opposite and identical.) Views 1,2 and 3 illustrate that this embodiment of the invention is one piece. This embodiment of the invention is shaped at the lower portion, 20, in a manner to allow the invention to be easily placed over the edge of a paper or paper-like traditional expandable file jacket. Also, near the lower portion of this embodiment, 21, the front and rear portions contact each other allowing the invention to fit tightly onto the said file jacket by means of the friction encountered when the invention is forced over the said jacket. The front and rear portions of the invention do not contact each other continually, 16, as illustrated in view 1 and view 2; allowing easy affixing and removal of the apparatus which is an embodiment of the invention. The illustrated surface at the top of this embodiment of the invention, 15, allows for affixing a label or writing a sign or creating a sign in Braille for the visually impaired.

FIG. 2. illustrates an alternate embodiment of the present invention. Numeral 6 indicates the front view of the embodiment. The embodiment is approximately square and about the size of the depth of a traditional file jacket on which the embodiment would be attached. Numeral 5 indicates a side view of the said embodiment. Numeral 7 indicates the stiff, rigid and durable material of which the embodiment is made. Numeral 8 indicates a layer of pressure-sensitive adhesive present on the back of the embodiment. Numeral 9 indicates a protective film to protect the adhesive until it is ready to be used. Numeral 4 indicates a perspective view of the embodiment as it is ready to be used; after peeling off the adhesive protecting film, 9.

Referring now to FIG. 3. FIG. 3 depicts a perspective view illustration, 10, of the embodiment of the present invention attached to a traditional five sided expandable file jacket, 11, by means of adhesive. The said embodiment of the present invention, 12, is a flat and rigid apparatus that when affixed in the manner illustrated, using the pressure sensitive adhesive indicated in said FIG. 2 by numeral 8 and protected until just before use by numeral 9 of said FIG. 2; prevents the said jacket, 11, from bending or folding along the built-in creases indicated in FIG. 3 by numeral 17. An identical apparatus, which is the present invention, is affixed by the same manner at the same location, near the top on the side; on both sides. The broken lines of FIG. 3 indicate parts of the invention, 12, which are hidden in the illustration.

Referring now to FIG. 4, a perspective view, 13, of a said expandable file jacket, 11, is illustrated with the preferred embodiment of the present invention apparatus, 14, installed and attached in identical manner at the top edge of both sides of the said file jacket, 11. The identical embodiments of the invention, 14 and 14, are affixed to the top edge of the end sides of said jacket, 11, by forcing the apparatus, 14, over the top edge of the said jacket; pushing the apparatus downward until the said top edge of said jacket contacts and seats the apparatus. The apparatus, which is the invention, 14, so affixed and seated now performs the task of continually holding the said file jacket, 11, fully open and fully expanded; to render said jacket, 11, a wide open container in which to easily place or remove documents using only one hand. The invention performs the said holding-open task by prevent the jacket from folding closed along the built-in fold creases in the paper or paper-like material of the said jacket, 17, which allow the said traditional file jacket, 11, to be expandable. The apparatus, which is the invention, 14, is constructed so as to be sufficiently stiff and rigid and durable to perform the task of not allowing the jacket to fold on the said built-in fold creases, 17.

FIG. 5 depicts a perspective view illustration, 18, of a file system constructed using an embodiment, 12, of the invention affixed at either end of each file jacket, 11, of a compilation of six identical, 11, said expandable file jackets. The said jackets are contained in a box, 19, sized purposely to fit the compilation of the said six file jackets. Any number of said file jackets and any suitably sized container could be used to complete a said system. The broken lines indicate parts of the apparatus, 12, hidden from view.

FIG. 6 depicts a possible label for a file system kit. Said label is meant to be seen and read attached to and displayed on such a kit product for sale using the present invention. This label is to be seen and considered by a person skilled in the art as they might be considering the practice of the product made possible and utilizing the present invention in its preferred embodiment. Upon consideration and study of FIG. 6 in it's entirety the features of the invention become more apparent.

The said accompanying drawings illustrate the present invention. Further described:

The present invention relates generally to an apparatus which is attached or affixed to a traditional five-sided (two end sides, a front side, a back side and a bottom side) expandable file folder which is traditionally referred to as a “file jacket.”

The present invention is affixed one each (identical) to each side of a said file jacket at the top of each side so as to prevent the said jacket to fold on the built-in fold creases of said jacket which allow the said jacket to expand in depth; thus continually maintaining the said expandable jacket in the fully open or fully expanded configuration. That is, of course, until the present invention might be removed so as to allow the said expandable jacket to collapse or unexpand for the purpose of compacting a plurality of said folders to reduce storage space. When in the said fully open or fully expanded configuration, documents or other items can be easily inserted into and removed from said open jacket using only one hand. The prior art requires two hands; one hand to open and hold open the said file jacket and other hand to then deposit or remove a document or other item from said jacket.

Further, when the apparatus which is the present invention is affixed in place as described herein and illustrated in the accompanying drawings; utilizing the preferred “clip-on”embodiment of the invention; the said preferred “clip-on” embodiment apparatus provides a surface on which to affix a label; or write a sign to indicate the contents of the jacket or whatever.

Further, the apparatus which is the present invention can be produced in various colors so an individual color can have a coordinating meaning as to locating items stored in said folder.

Further, the preferred embodiment of the apparatus which is the invention provides a surface on which the language of Braille can be written for sight impaired persons.

Further, when the apparatus which is the present invention is affixed as described herein, a label written onto the uppermost portion of the back of the said expandable file jacket facing forward is easier to read than prior art because that said portion of said jacket is the maximum distance from the front of the said jacket due to the held-open configuration of said jacket due to the installation of the present invention. This said maximum distance space allows the said label to be easily seen. This easy-to-be-seen feature created by the present invention is desirable because prior art suggests that many said jacket are often stored in a front-to-back/front-to-back configuration. In such a configuration the traditional five sided file jacket construction, used according to prior art, would allow said jackets to collapse against each other causing labels on the said collapsed jacket to hidden by other collapsed file jackets.

Further, this invention is the necessary part of a further embodiment which is the Drop Easy File System illustrated and explained in FIG. 5 and FIG. 6 of the accompanying drawings herein. The said system, which consists of the apparatus which is the present invention, installed onto a compilation of six (or more or less) file jackets fitted together front to back and contained in a box designed to hold the said compilation.

What I claim is:

1. An apparatus which is to be attached to a traditional expandable file jacket so as to cause said jacket to be maintained constantly and continually, for as long as desired, in the maximum open configuration.

2. The apparatus as set forth in claim 1, wherein the said attaching apparatus is a rigid one piece apparatus configured to slide over or “clip” onto the top edge of the side of said traditional expandable file jacket.

3. The apparatus as set forth in claim 1, wherein the said attaching apparatus is a rigid apparatus configured to attach by means of adhesive or mechanical fasteners to the side of said traditional expandable file jacket.

4. A system in which traditional expandable file jackets are fitted with the apparatus as set forth in claim 1. and further fitted into a purpose sized container.
